(19) United States
(12) Patent Application Publication
(10) Pub. No.: US 2003/0112013 A1
(43) Pub. Date: Jun. 19, 2003

(54) Potentiometric sensor

(76) Inventors: Andreas Manz, Surrey (GB); Ratna Tantra, London (GB)

Correspondence Address: Nixon & Vanderhye, 8th Floor, 1100 North Glebe Road, Arlington, VA, 22201-4714, US

(21) Appl. No.: 10/148,969

(22) PCT Filed: Dec. 8, 2000
(86) PCT No.: PCT/GB00/04711

(51) Int. Cl. G01N 27/60

(52) U.S. Cl. 324/453

(57) ABSTRACT

A microfabricated potentiometric sensor and a method of measuring the activity of analyte ions in a sample solution, the sensor comprising: a substrate chip; a flow channel defined by the substrate chip through which analyte ions of a sample solution are in use driven; at least one ion-selective electrode comprising a chamber defined by the substrate chip and including a port in communication with the flow channel, an ion-selective membrane disposed in the chamber, and a conductive element configured such as in use to be in electrical connection with the ion-selective membrane; a reference electrode configured such as in use to be in electrical connection with the flow channel; whereby, on driving analyte ions of a sample solution through the flow channel, an electromotive force is developed between the at least one ion-selective electrode and the reference electrode which is representative of the activity of the analyte ions.

The present invention relates to a microfabricated chip-based potentiometric sensor which includes at least one ion-selective membrane electrode, and a measurement system incorporating the same.

Ion-selective membrane electrodes are electrochemical electrodes that can be used in the direct measurement of the activity, and hence concentration, of analyte ions in sample solutions, particularly complex organic solutions. Selectivity for one species over another is determined by the nature and chemical composition of the ion-selective membrane and the associated reaction layers used to fabricate the electrode. Such ion-selective membranes serve as an additional component of a classic two-electrode galvanic cell, with the potential developed at the interface between the membrane and the sample solution being directly or indirectly related to the activity of the analyte ions in the sample solution.

The measurement principle of electrochemical cells incorporating ion-selective membrane electrodes is quite simple. Two electrodes are separated by an ion-selective membrane, with the solution on one side of the membrane being an internal reference solution of known composition and including ions to which one electrode, referred to as the internal electrode, and the membrane respond, and the solution on the other side of the membrane being a sample solution in contact with the other electrode, referred to as the external reference electrode.

In such electrochemical cells the phase-boundary potentials will be constant except for the membrane potential which is the difference in the electrical potential between the internal reference solution and the sample solution; the variation in this membrane potential being an indication of the activity of the analyte ions in the sample solution. In practice, the internal electrode, the internal reference solution and the ion-selective membrane are often housed in a single unit to provide an ion-selective electrode. In this arrangement the voltage is measured as an electromotive force (EMF) between the ion-selective electrode (ISE) and the reference electrode (RE) according to the formula

EMF=E_{ISE}−E_{RE}.

Ion-selective microelectrodes for measuring ionic activity have been in existence for some time as discussed in the review article by Thomas Bührer et al entitled “Neutral-Carrier-Based Ion-Selective Microelectrodes Design and Application A Review” as published in Analytical Sciences, December 1998, Vol. 4, pages 547 to 557.

Early measurement systems using ion-selective microelectrodes were based on glass micropipettes. These measurement systems demonstrated the feasibility of detecting inorganic anions and cations using ion-selective microelectrodes.

More recently, polymeric electrode membranes have been developed which behave as a viscous liquid. These polymeric electrode membranes, typically formed of polyvinyl chloride or silicone rubber, provide for improved durability and have led to the development of a new kind of ion-selective electrode, namely, the coated wire electrode (CWE), which is more robust than the early micropipette-based electrodes. Coated wire electrodes comprise a conductive element, typically a metal wire, coated with a polymeric ion-selective membrane, and provide very small, durable ion-selective electrodes. Whilst such coated wire electrodes are mechanically simple, a significant problem associated with those electrodes is that, in having no internal reference solution at the interface between the conductive element and the ion-selective membrane, the coupling between the conductive element and the ion-selective membrane depends upon the conditions at the interface and these conditions change with time. The consequence of this change in the coupling between the conductive element and the ion-selective membrane is a drift in the electrode potential and this drift undesirably necessitates frequent calibration of any measurement system incorporating coated wire electrodes.

Still more recently, ion-selective membranes have been incorporated in microfabricated silicon devices, which development provides the real prospect of mass-production.

Significant recent interest has focused on devices incorporating an ion-selective membrane in contact with the gate of a solid-state field effect transistor (FET), which devices are referred to as ISFETs or CHEMFETs. The principle of operation of these ISFETs or CHEMFETs is that the outer membrane phase-boundary potential determines the voltage at the gate of the field effect transistor, and, when the field effect transistor is a current-measuring circuit, the resulting current should be indicative of the membrane potential and hence the activity of the analyte ions in the sample solution. Although these devices are very small, of low noise and robust, drawbacks still exist. The most significant problem associated with these devices is the same problem associated with coated wire electrodes, namely, that of drift arising as a result of changes in the coupling between the gate of the field effect transistor and the ion-selective membrane. Typically, the coupling is influenced by certain species diffusing through the ion-selective membrane to the interface with the gate of the field effect transistor.

Microfabricated potentiometric sensors have also been developed in silicon wafers, as disclosed in a paper by Uhlig et al entitled “Miniaturized Ion-Selective Chip Electrode for Sensor Application” as published in Analytical Chemistry, Vol. 69, No. 19, pages 4032 to 4038. These miniaturised sensors are fabricated by depositing a polymeric ion-selective membrane into anisotropically etched wells in a silicon wafer, and, in use, a sample solution is brought into contact with one side of the silicon wafer.

Whilst the above-mentioned potentiometric sensors are all of scientific interest, these sensors require a significant equilibration time as the diffusion flux of the analyte ions in the hydrostatic sample solutions used by the sensors is relatively low.

It is thus an aim of the present invention to provide a microfabricated chip-based potentiometric sensor which is robust and provides for analyte ions in sample solutions to be driven relative to an ion-selective membrane and thereby allow rapid measurement. In this way, the potentiometric sensor of the present invention provides means for performing on-line measurements, preferably continuously.

Accordingly, the present invention provides a microfabricated potentiometric sensor, comprising: a substrate chip; a flow channel defined by the substrate chip through which analyte ions of a sample solution are in use driven; at least one ion-selective electrode comprising a chamber defined by the substrate chip and including a port in communication with the flow channel, an ion-selective membrane disposed in the chamber, and a conductive element configured such as in use to be in electrical connection with the ion-selective membrane; a reference electrode configured such as in use to be in electrical connection with the flow channel; whereby, on driving analyte ions of a sample solution through the flow channel, an electromotive force is developed between the at least one ion-selective electrode and the reference electrode which is representative of the activity of the analyte ions.

The construction of this sensor, in requiring the analyte ions of a sample solution to be driven through a flow channel, provides a sufficient diffusion flux of the analyte ions, as compared to the ionic diffusion flux in a hydrostatic sample solution, that the activity of the analyte ions can be rapidly measured.

In preferred embodiments the ion-selective membrane includes one or both of an appropriate lipophilic ionophore or an ion exchanger as the ion-transfer agent.

In one embodiment the chamber is filled completely by the ion-selective membrane.

In another embodiment the chamber is filled partially by the ion-selective membrane.

Preferably, the chamber comprises a first region, and at least one second, junction region of smaller dimension than the first region in communication with the flow channel.

More preferably, the chamber comprises a plurality of junction regions, each being in communication with respective ones of spaced locations in the flow channel.

Still more preferably, the junction regions are in communication with locations spaced along the length of the flow channel.

Preferably, the at least one ion-selective electrode further comprises a reference solution, with the conductive element being disposed in the reference solution such as to be in electrical connection with the ion-selective membrane through the reference solution.

Preferably, the sensor comprises a plurality of ion-selective electrodes, with the ports of the chambers of the ion-selective electrodes being in communication with respective ones of spaced locations in the flow channel.

More preferably, the ports of the chambers of the ion-selective electrodes are in communication with locations spaced along the length of the flow channel.

Preferably, the reference electrode comprises a further chamber defined by the substrate chip and including a port in communication with the flow channel, a conductive material disposed in the further chamber, and a further conductive element configured such as in use to be in electrical connection with the conductive material.

In one embodiment the further chamber is filled completely by the conductive material.

In another embodiment the chamber is filled partially by the conductive material.

Preferably, the further chamber comprises a first region, and at least one second, junction region of smaller dimension than the first region in communication with the flow channel.

Preferably, the reference electrode further comprises a further reference solution, with the further conductive element being disposed in the further reference solution such as to be in electrical connection with the conductive material through the further reference solution.

In one embodiment the flow channel includes inlet and outlet ports through which a liquid flow of the sample solution is in use driven.

In another embodiment the sensor is configured such that analyte ions are electrically driven through the flow channel.

Preferably, the flow channel includes an inlet port through which a volume of a sample solution is in use introduced thereinto, and the sensor further comprises first and second conductive elements disposed such as to generate a potential gradient along the flow channel when a d.c. high voltage is applied thereacross.

The present invention also extends to a measurement system for measuring the activity of analyte ions in a sample solution which incorporates the above-described potentiometric sensor. Such measurement systems would find application in the clinical and environmental fields.

The present invention also provides a method of measuring the activity of analyte ions in a sample solution, comprising the steps of: providing a potentiometric sensor comprising a substrate chip defining a flow channel, at least one ion-selective electrode in communication with the flow channel, and a reference electrode in communication with the flow channel; driving analyte ions of a sample solution through the flow channel; and measuring the electromotive force developed between the at least one ion-selective electrode and the reference electrode so as to determine the activity of the analyte ions.

In one embodiment the sample solution is fed as a liquid flow through the flow channel.

Preferably, the sample solution is fed through the flow channel at a flow rate of from 1 pl/s to 1 ml/s.

In another embodiment the analyte ions are electrically driven by electrohydrodynamic or electroosmotic flow along the flow channel.

Preferably, a volume of a sample solution is introduced into the flow channel prior to applying the driving voltage.

Preferred embodiments of the present invention will now be described hereinbelow by way of example only with reference to the accompanying drawings, in which:

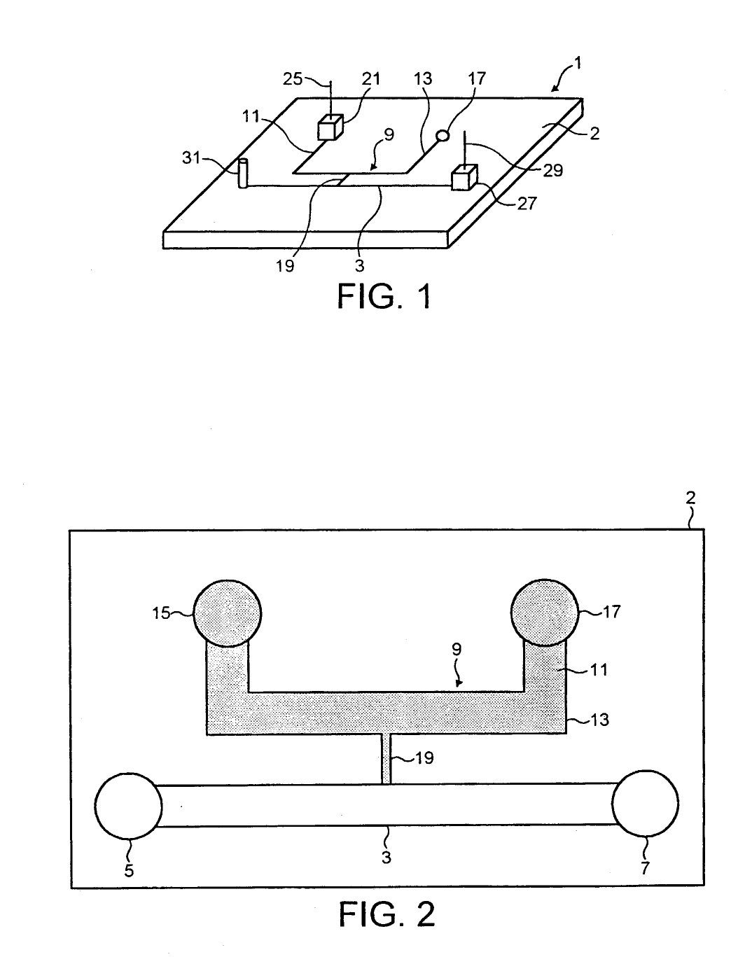

FIG. 1 schematically illustrates in perspective view a chip-based potentiometric sensor in accordance with a first embodiment of the present invention;

FIG. 2 illustrates the chip layout of the sensor of FIG. 1;

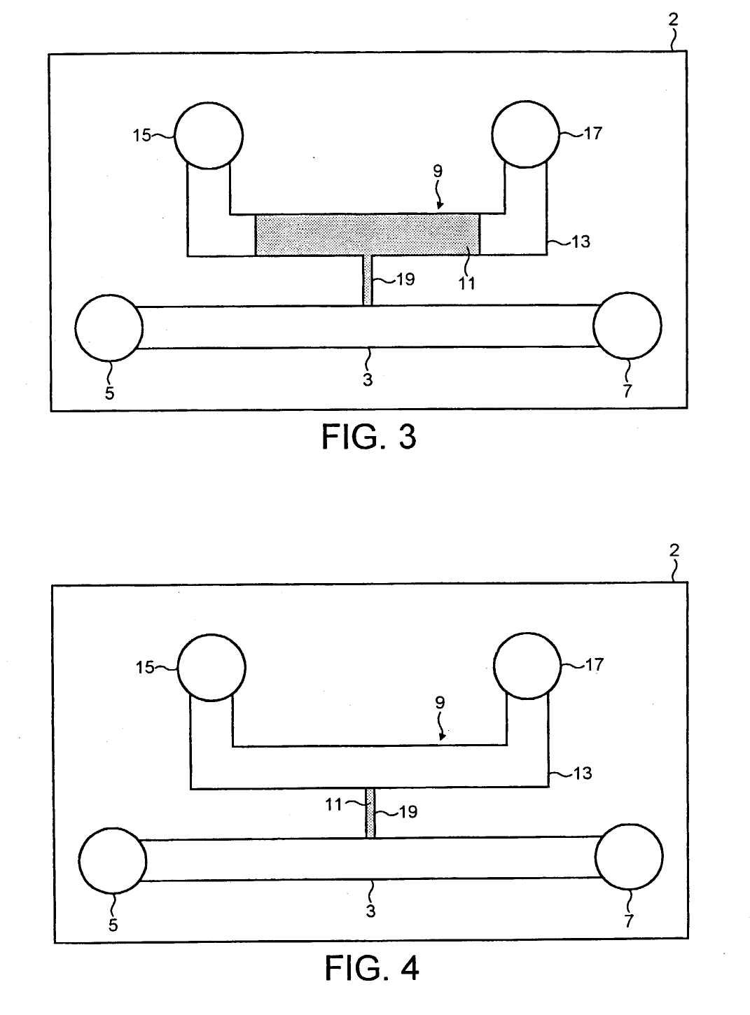

FIG. 3 illustrates a first modified chip layout of the sensor of FIG. 1;

FIG. 4 illustrates a second modified chip layout of the sensor of FIG. 1;

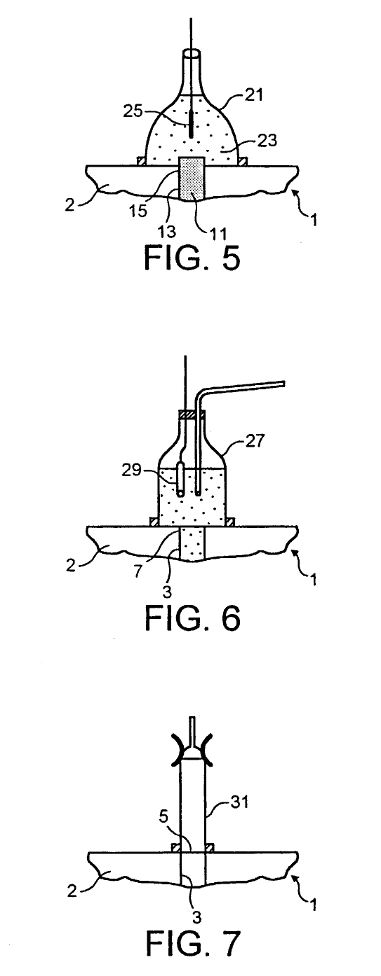

FIG. 5 illustrates schematically a sectional view of the ion-selective electrode of the sensor of FIG. 1;

FIG. 6 illustrates schematically a sectional view of the sample solution reservoir and the reference electrode of the sensor of FIG. 1;

FIG. 7 illustrates schematically a sectional view of the inlet configuration of the flow channel of the sensor of FIG. 1;

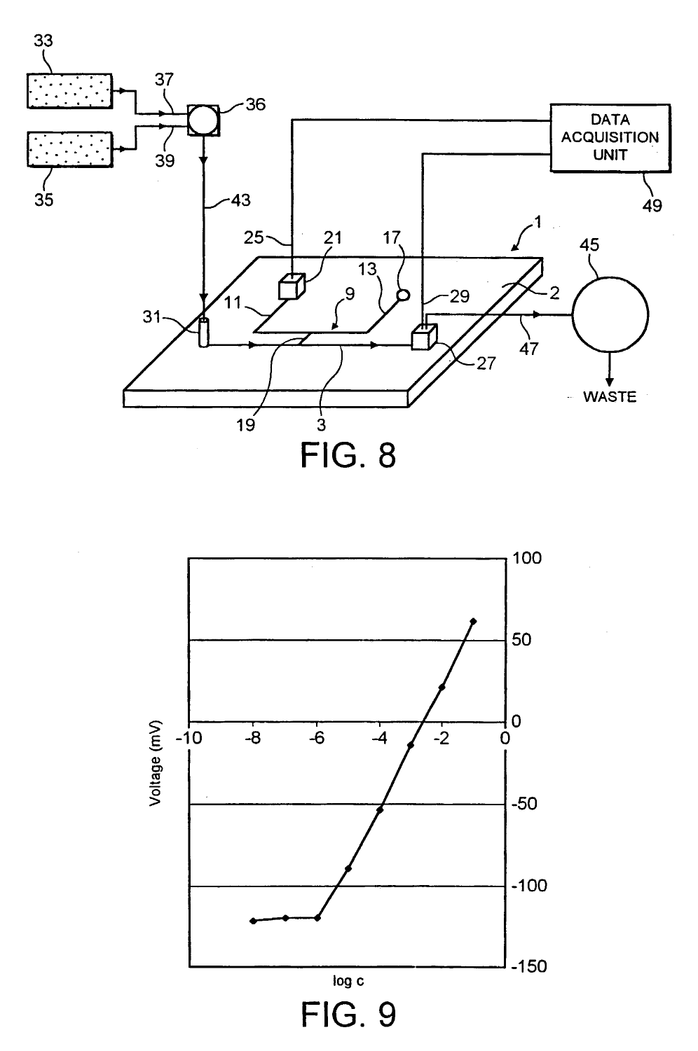

FIG. 8 schematically illustrates in perspective view a measurement system incorporating the sensor of FIG. 1;

FIG. 9 illustrates a plot of electromotive force as a function of the log of concentration for a sample solution measured using the sensor of FIG. 1;

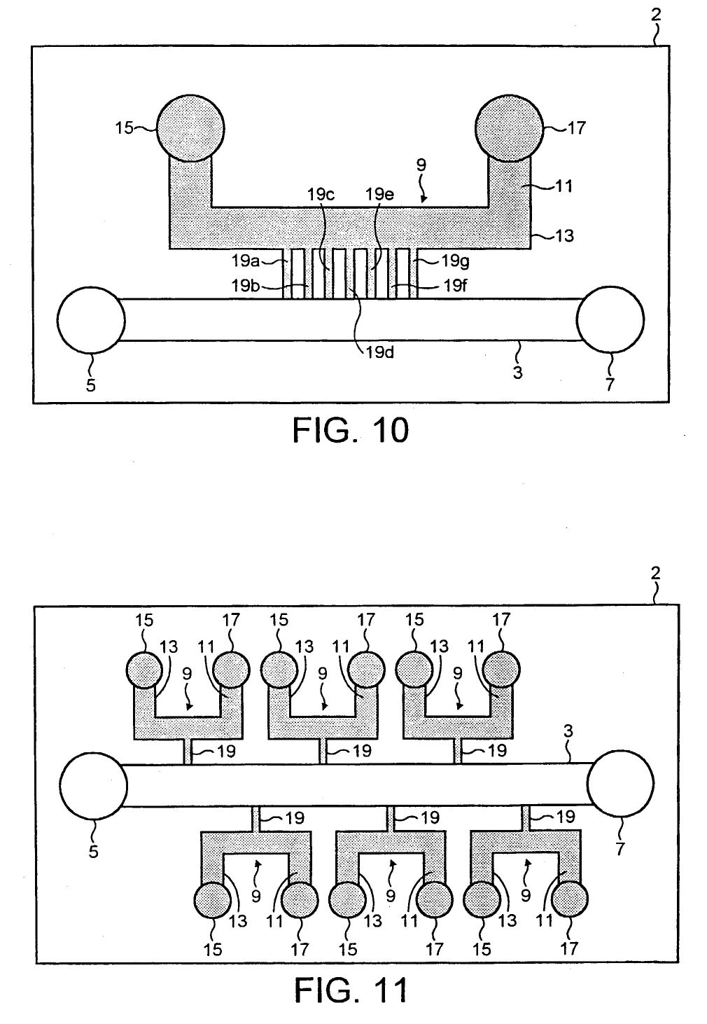

FIG. 10 illustrates the chip layout of a chip-based potentiometric sensor in accordance with a second embodiment of the present invention;

FIG. 11 illustrates the chip layout of a chip-based potentiometric sensor in accordance with a third embodiment of the present invention;

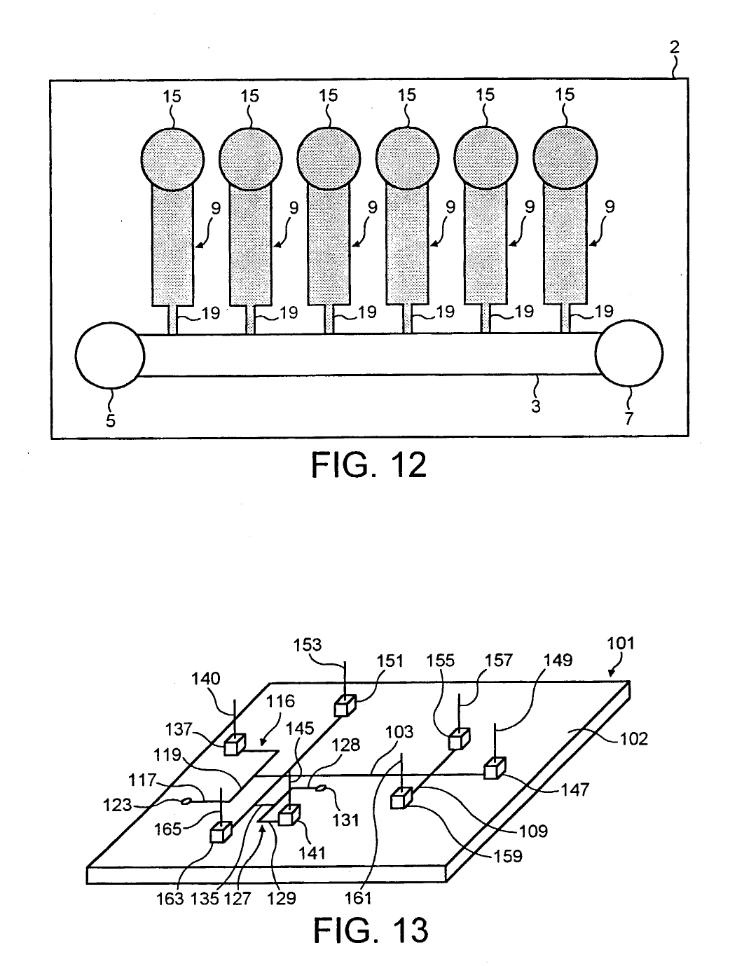

FIG. 12 illustrates the chip layout of a chip-based potentiometric sensor in accordance with a fourth embodiment of the present invention;

FIG. 13 schematically illustrates in perspective view a chip-based potentiometric sensor in accordance with a fifth embodiment of the present invention;

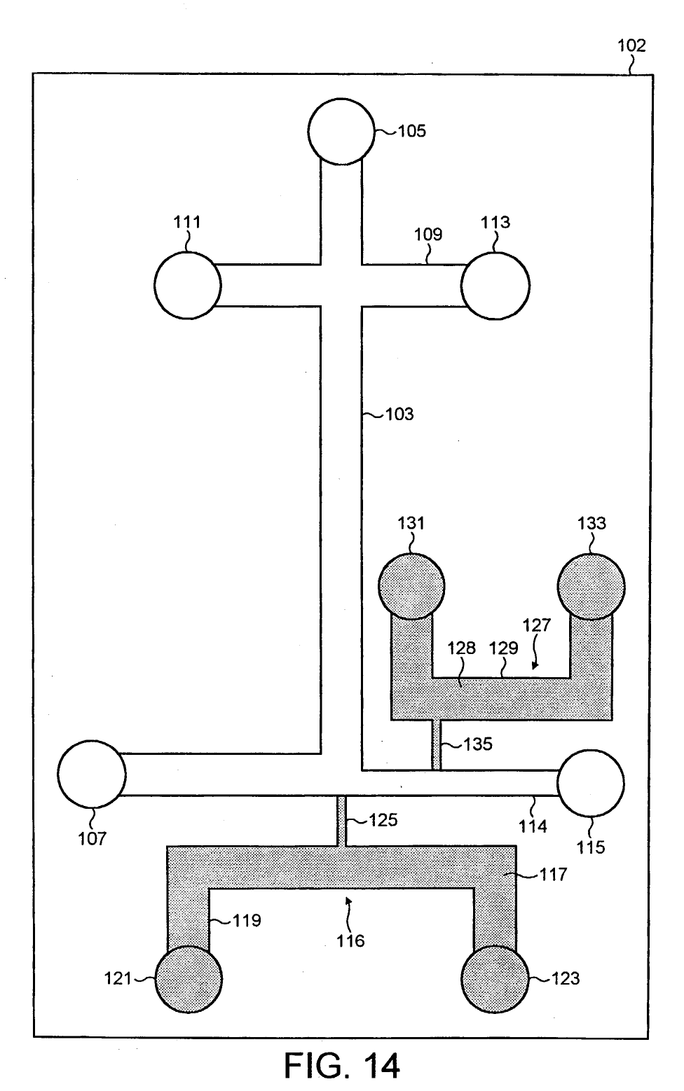

FIG. 14 illustrates the chip layout of the sensor of FIG. 13;

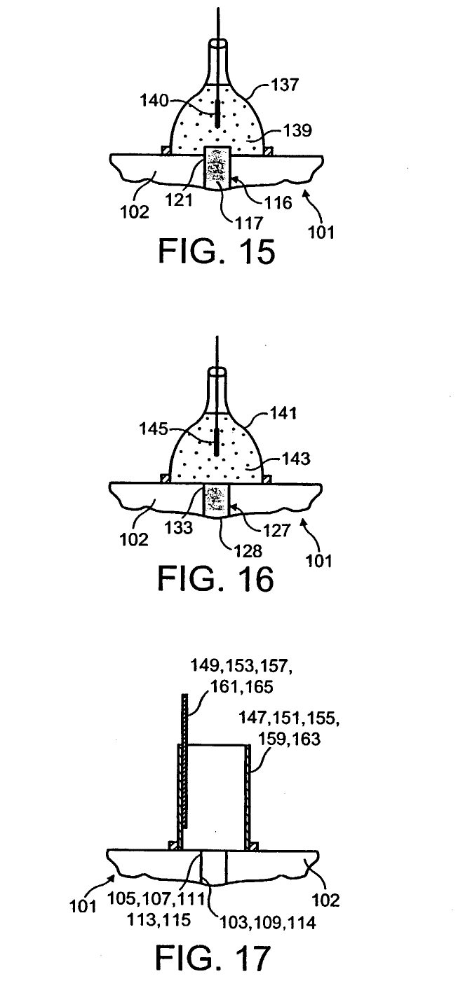

FIG. 15 illustrates schematically a sectional view of the ion-selective electrode of the sensor of FIG. 13;

FIG. 16 illustrates schematically a sectional view of the reference electrode of the sensor of FIG. 13;

FIG. 17 illustrates schematically a sectional view of the third to seventh tubular sections and associated electrode elements of the sensor of FIG. 13;

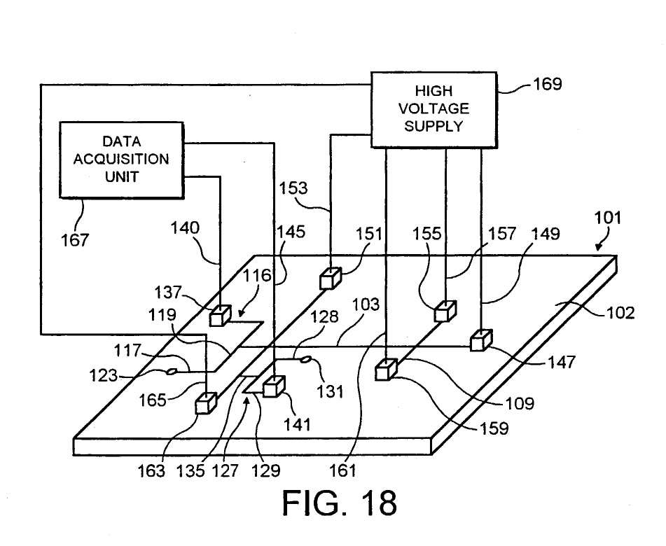

FIG. 18 schematically illustrates in perspective view a measurement system incorporating the sensor of FIG. 13; and

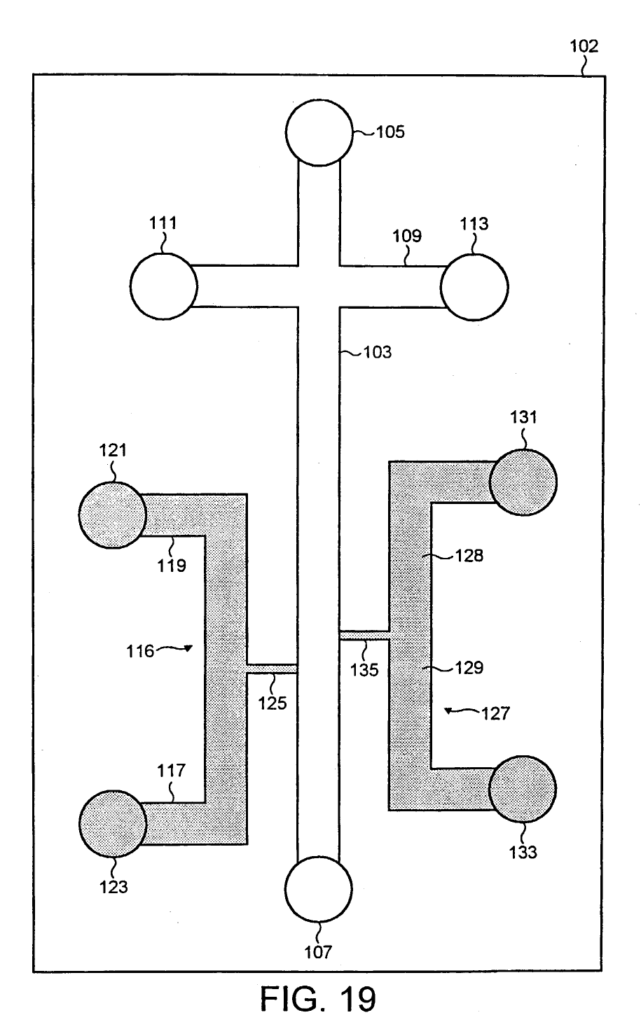

FIG. 19 illustrates the chip layout of a chip-based potentiometric sensor in accordance with a sixth embodiment of the present invention.

FIG. 1 illustrates a microfabricated potentiometric sensor 1 in accordance with a first embodiment of the present invention as fabricated in a substrate chip 2.

The chip 2 includes flow channel 3, in this embodiment of linear section, which includes an inlet port 5 and an outlet port 7 through which a sample solution is in use fed. In this embodiment the flow channel 3 is 10 mm in length, 200 μm in width and 20 μm in depth.

The chip 2 further includes a chamber 9 which contains an ion-selective membrane 11. The chamber 9 comprises a first, main region 13, in this embodiment of flattened U-shaped section, which includes first and second ports 15, 17 and a second, narrow junction region 19 which is in fluid communication with the flow channel 3 and extends substantially between midpoints of the main region 13 and the flow channel 3. In this embodiment the main region 13 is 12 mm in length, 200 μm in width and 20 μm in depth, the first and second ports 15, 17 are 800 μm in diameter, and the junction region 19 is 830 μm in length, 20 μm in width and 20 μm in depth.

In this embodiment, as illustrated in FIG. 2, the chamber 9 is filled completely with the ion-selective membrane 11. In other modified chips 2, however, as illustrated in FIGS. 3 and 4, the chamber 9 can be partially filled with ion-selective membrane 11. In the modification of FIG. 3, the ion-selective membrane 11 fills only the junction region 19 and the web of the U-shaped main region 13 of the chamber 9. In the modification of FIG. 4, the ion-selective membrane 11 fills only the junction region 19 of the chamber 9.

In one embodiment the chamber 9 can include an inert, porous supporting material, such as a ceramic, which is provided to support the ion-selective membrane 11 and improve the mechanical stability thereof.

The chip 2 is fabricated from two plates, in this embodiment composed of microsheet glass. In an alternative embodiment the plates could be formed of silicon wafers. In a first step, one of the plates is etched by HF wet etching to form wells which define the flow channel 3 and the main and junction regions 13, 19 of the chamber 9, with the wells having the respective dimensions mentioned hereinabove. In a second step, four holes are drilled, in this embodiment by ultrasonic abrasion, into the other plate so as to provide the inlet and outlet ports 5, 7 of the flow channel 3 and the first and second ports 15, 17 of the chamber 9. In a third step, the two plates are bonded together by direct fusion bonding. In a fourth step, the chamber 9 is filled with an organic cocktail which provides the ion-selective membrane 11. Filling is achieved by maintaining a gas flow, typically of an inert gas such as argon, through the flow channel 3 and introducing a predetermined volume of the organic cocktail into one of the ports 15, 17 of the chamber 9. In this way, the main and junction regions 13, 19 of the chamber 9 are filled with the organic cocktail; organic cocktail being prevented from entering the flow channel 3 by the gas flow maintained therethrough. Where the chamber 9 is to include an inert, porous supporting material, this material is introduced prior to or after fusing together the two plates. In a fifth and final step, where necessary, such as for certain polymer-containing organic cocktails, the chip 2 is allowed to stand until the solvent in the organic cocktail of the ion-selective membrane 11 has evaporated and a dry ion-selective membrane 11 is formed. Typically, the chip 2 can be dried in a desiccator.

In this embodiment the organic cocktail comprises tetrahydrofuran (THF) as a solvent, o-nitrophenyloctyl ether (o-NOPE) as a solvent mediator, polyvinyl chloride (PVC) as a polymeric matrix material, potassium tetrakis(4-chlorophenyl)borate (TPB) as a lipophilic salt for reducing electrical resistance, and an ion-transfer agent. Other suitable polymeric matrix materials include fluorosilicone elastomers which have a relatively low resistance and high dielectric constant.

In a preferred embodiment the chamber 9 can be surface treated so as to be of increased hydrophobicity. Preferably, the chamber 9 is silanized by treating with a silane solution. Appropriate silane solutions include the siloxane based solution Repelcote™ and 5% dimethvlchlorosilane in carbon tetrachloride. In practice. the chamber 9 is treated after bonding together the two plates by feeding a metered volume of silane solution, typically using a syringe needle, into one of the ports 15, 17 of the chamber 9 and simultaneously applying a vacuum, typically using a vacuum pump, to the other of the ports 15, 17 of the chamber 9 so as to fill the same. In order to prevent the silane solution entering the flow channel 3, a gas flow, typically an inert gas such as argon, is maintained in the flow channel 3. The silane solution is maintained in the chamber 9 for a short time, typically from 2 to 3 minutes, and then completely withdrawn using the vacuum pump. This process is then repeated so as to ensure complete silanization of the chamber 9.

The sensor 1 further comprises a first tubular section 21, one of the ends of which is enlarged and bonded to the chip 2, in this embodiment by an epoxy resin, so as to overlie the first port 15 of the chamber 9; the first tubular section 21 defining a reservoir which contains an internal reference solution 23, in this embodiment 0.1 M of KCl.

The sensor 1 further comprises an electrode element 25, in this embodiment an Ag/AgCl wire, disposed in the reference solution 23 contained by the first tubular section 21.

The sensor 1 further comprises a second tubular section 27, one of the ends of which is enlarged and bonded to the chip 2, in this embodiment by an epoxy resin, so as to overlie the outlet port 7 of the flow channel 3; the second tubular section 27 defining a reservoir for containing the sample solution fed through the flow channel 3.

The sensor 1 further comprises a reference electrode 29 disposed in the second tubular section 27 so as to contact the sample solution when contained therein. In this embodiment the reference electrode 29 comprises a Flexref™ minaturized Ag/AgCl electrode as available from World Precision Instruments of Stevenage, UK.

The sensor 1 further comprises a third tubular section 31, in this embodiment a fused silica capillary tube, bonded to the chip 2, in this embodiment by an epoxy resin, so as to overlie the inlet port 5 of the flow channel 3.

With this configuration, the ion-selective membrane 11, the reference solution 23 and the electrode element 25 together define an ion-selective electrode, such that, on feeding a sample solution through the flow channel 3, a potential is developed across the ion-selective electrode and the reference electrode 29 corresponding to the membrane potential which is the electrical potential between the reference solution 23 and the sample solution and is representative of the activity of the analyte ions in the sample solution.

FIG. 8 illustrates a measurement system incorporating the above-described potentiometric sensor 1.

The measurement system comprises first and second solution feeders 33, 35, in this embodiment syringe pumps, and a valve switch 36, with the solution feeders 33, 35 being connected by tubing 37, 39 to the inlets of the valve switch 36 and by tubing 43 to the third tubular section 31 at the inlet port 5 of the flow channel 3. By providing two solution feeders 33, 35 and a valve switch 36, the concentration of the sample solution fed to the flow channel 3 can be altered without any interruption to the flow and hence measurement cycle.

The measurement system further comprises a pump 45, in this embodiment a peristaltic pump, connected by tubing 47 to the sample solution reservoir defined by the second tubular section 27 for feeding the measured solution to waste.

The measurement system further comprises a data acquisition unit 49 for logging the electromotive force developed across the ion-selective electrode and the reference electrode 29 of the sensor 1. In this embodiment the data acquisition unit 49 comprises a PICO-LOG™ data acquisition system as available from Pico-Technology of Cambridge, UK connected to the ion-selective electrode and the reference electrode 29 through a buffer amplifier for converting the high impedance voltage to a low impedance voltage.

In use, the solution feeders 33, 35 and the valve switch 36 are configured to feed a sample solution having known concentration at a predetermined flow rate through the flow channel 3 of the sensor 1. As this sample solution is fed through the flow channel 3 the electromotive force generated across the ion-selective electrode and the reference electrode 29 is logged by the data acquisition unit 49, which data can be used to provide an on-line measurement of the activity of the analyte ions in the sample solution.

This embodiment will now be described with reference to the following non-limiting Example.

### EXAMPLE

A potentiometric sensor 1 as described hereinabove was fabricated for measuring the concentration of BaCl₂ in water. In this sensor 1 the ion-selective membrane 11 was formed from an organic solution comprising 1 mL of o-NOPE, 70 mg of PVC, 2 mg of TPB salt. 7 mg of Ba²⁺ Vogtle ionophore and 0.5 ml of THF.

Using the measurement system described hereinabove the electromotive force was measured at various concentrations (c) of BaCl₂ in water at a flow rate of 1/60 μl/s and intervals of 5 seconds.

The results of this measurement are shown graphically in FIG. 9 as a plot of electromotive force as a function of log c. These results show that the signal from the sensor 1 was very stable and capable of giving rapid, reproducible responses in the range of from 10⁻¹ to 10⁻⁶ M. Indeed, as shown in FIG. 9, the sensor 1 exhibits a near Nernistan slope of 36 mV/decade (c.f. a theoretical 29 mV/decade).

FIG. 10 illustrates the chip layout of a chip 2 of a potentiometric sensor 1 in accordance with a second embodiment of the present invention. This chip 2 is substantially identical to that of the above-described first embodiment, and thus in order to avoid unnecessary duplication of description only the differences will be described in detail, with like parts being designated by like reference signs. This chip 2 differs from that of the first-described embodiment only in that the chamber 9 includes a plurality of junction regions 19a-g, each being in fluid communication with respective ones of locations spaced along the length of the flow channel 3. With this configuration, the electromotive force developed between the ion-selective electrode and the reference electrode 29 is a signal average representing the bulk activity of the analyte ions in the volume of the sample solution bounded by the upstreammost and downstreammost junction regions 19a, 19g.

FIG. 11 illustrates the chip layout of a chip 2 of a potentiometric sensor 1 in accordance with a third embodiment of the present invention. This chip 2 is quite similar to that of the above-described first embodiment, and thus in order to avoid unnecessary duplication of description only the differences will be described in detail, with like parts being designated by like reference signs. This chip 2 differs from that of the first-described embodiment in including a plurality of chambers 9, the junction regions 19 of which are in fluid communication with respective ones of locations spaced along the length of the flow channel 3, and with each of the first ports 15 of the chambers 9 including an associated first tubular section 21 and electrode element 25 such as to define a plurality of ion-selective electrodes. With this configuration, the electromotive force developed between each of the ion-selective electrodes and the reference electrode 29 can be measured, and, where the ion-selective membrane 11 in each of the ion-selective electrodes is selected so as to be selective for different analyte ions, an integrated multi-analyte sensor is provided.

FIG. 12 illustrates the chip layout of a chip 2 of a potentiometric sensor 1 in accordance with a fourth embodiment of the present invention. This chip 2 is quite similar to that of the above-described third embodiment, and thus, in order to avoid unnecessary duplication of description, only the differences will be described in detail, with like parts being designated by like reference signs. This chip 2 differs from that of the third-described embodiment only in that the main regions 13 of the chambers 9 are of linear section and include only a single port 15. As with the third-described embodiment, where the ion-selective membrane 11 of each of the ion-selective electrodes is selected so as to be selective for different analyte ions, an integrated multi-analyte sensor is provided.

FIG. 13 illustrates a microfabricated potentiometric sensor 101 in accordance with a fifth embodiment of the present invention as fabricated in a substrate chip 102.

The chip 102 includes a first, separation channel 103, in this embodiment L-shaped in section, which includes first and second ports 105, 107 and through which the analyte ions of a sample solution are in use driven. In this embodiment the separation channel 103 has a width of 50 μm and a depth of 10 μm.

The chip 102 further includes a second, delivery channel 109, in this embodiment of linear section, which intersects the separation channel 103 and includes first and second ports 111, 113, through which delivery channel 109 a sample solution is in use introduced into the separation channel 103. In this embodiment the delivery channel 109 has a width of 50 μm and a depth of 10 μm.

The chip 102 further includes a third, spur channel 114, in this embodiment of linear section, which is in fluid communication with the knee of the separation channel 103 and includes a port 115.

The chip 102 further includes a first chamber 116 which contains an ion-selective membrane 117 and is of the same construction as the chamber 9 of the above-described first embodiment. The first chamber 116 comprises a first, main region 119, in this embodiment of flattened U-shaped section, which includes first and second ports 121, 123, and a second, narrow junction region 125 which is in fluid communication with the separation channel 103 and extends between the knee thereof and substantially the midpoint of the main region 119 of the first chamber 116.

The chip 102 further includes a second chamber 127 which contains a conductive material 128, in this embodiment a conductive polymeric membrane. The second chamber 127 comprises a first, main region 129, in this embodiment of flattened U-shaped section, which includes first and second ports 131, 133 and a second, narrow junction region 135 which is in fluid communication with the spur channel 114. In this embodiment the main region 129 is 12 mm in length, 200 μm in width and 20 μm in depth, the first and second ports 131, 133 are 800 μm in diameter, and the junction region 135 is 830 μm in length, 20 μm in width and 20 μm in depth.

In this embodiment, as illustrated in FIG. 14, the second chamber 127 is filled completely with conductive material 128. In other modified chips 102, however, the second chamber 127 can be partially filled with conductive material 128. In one modification, the conductive material 128 fills only the junction region 135 and the web of the U-shaped main region 129 of the second chamber 127. In another modification, the conductive material 128 fills only the junction region 135 of the second chamber 127.

The chip 102, as with that of the above-described first embodiment, is fabricated from two plates. In this embodiment the plates are composed of microsheet glass, but in an alternative embodiment could be formed of silicon wafers. In a first step, one of the plates is etched by HF wet etching to form wells which define the first, second and third channels 103, 109, 114 and the first and second chambers 116, 127, with the wells having the respective dimensions mentioned hereinabove. In a second step, nine holes are drilled, in this embodiment by ultrasonic abrasion, into the other plate so as to provide the ports 105, 107 of the first, separation channel 103, the ports 111, 113 of the second, delivery channel 109, the port 115 of the third, spur channel 114, the ports 121, 123 of the first chamber 116 and the ports 131, 133 of the second chamber 127. In a third step, the two plates are bonded together by direct fusion bonding. In a fourth step, the first chamber 116 is filled with an organic cocktail which provides the ion-selective membrane 117 in the same manner as the chamber 9 of the first-described embodiment. In a fifth step, the second chamber 127 is filled with a polymeric solution, which provides the conductive material 128, in the same manner as the first chamber 116 is filled with the organic cocktail. In a sixth and final step, the chip 102 is allowed to stand until the solvents in the organic cocktail of the ion-selective membrane 117 and the polymeric solution of the conductive material 128 have evaporated and the ion-selective membrane 117 and conductive material 128 are formed. Typically, the chip 102 is dried in a desiccator. As with the above-described first embodiment, the first and second chambers 116, 127 can be surface treated so as to be of increased hydrophobicity.

In this embodiment, again as with the above-described first embodiment, the organic cocktail comprises tetrahydrofuran (THF) as a solvent, o-nitrophenyloctyl ether (o-NOPE) as a solvent mediator, polyvinyl chloride (PVC) as a polymeric matrix material, potassium tetrakis(4-chlorophenyl)borate (TPB) as a lipophilic salt for reducing electrical resistance, and an ion-transfer agent.

The sensor 101 further comprises a first tubular section 137, one of the ends of which is enlarged and bonded to the chip 102, in this embodiment by an epoxy resin, so as to overlie the first port 121 of the first chamber 116; the first tubular section 137 defining a reservoir which contains an internal reference solution 139, in this embodiment 0.1 M of KCl.

The sensor 101 further comprises a first electrode element 140, in this embodiment an Ag/AgCl wire, disposed in the internal reference solution 139 contained by the first tubular section 137.

The sensor 101 further comprises a second tubular section 141, one of the ends of which is enlarged and bonded to the chip 102, in this embodiment by an epoxy resin, so as to overlie one of the ports 133 of the second chamber 127; the second tubular section 141 defining a reservoir for containing an external reference solution 143, in this embodiment 0.1 M KCl.

The sensor 101 further comprises a second electrode element 145, in this embodiment an Ag/AgCl wire, disposed in the external reference solution 143 contained by the second tubular section 141.

With this configuration, the ion-selective membrane 117, the internal reference solution 139 and the first electrode element 140 together define an ion-selective electrode and the conductive material 128, the external reference solution 143 and the second electrode element 145 together define a reference electrode, such that, on driving analyte ions of a sample solution through the separation channel 103, a potential is developed across the ion-selective electrode and the reference electrode which corresponds to the membrane potential and is representative of the activity of the analyte ions.

The sensor 101 further comprises a third tubular section 147, one of the ends of which is bonded to the chip 102, in this embodiment by an epoxy resin, so as to overlie the first port 105 of the separation channel 103 and define a reservoir, and a third electrode element 149 disposed in the reservoir defined by the third tubular section 147.

The sensor 101 further comprises a fourth tubular section 151, one of the ends of which is bonded to the chip 102, in this embodiment by an epoxy resin, so as to overlie the second port 107 of the separation channel 103 and define a reservoir, and a fourth electrode element 153 disposed in the reservoir defined by the fourth tubular section 151.

The sensor 101 further comprises a fifth tubular section 155, one of the ends of which is bonded to the chip 102, in this embodiment by an epoxy resin, so as to overlie the first port 111 of the delivery channel 109 and define a reservoir, and a fifth electrode element 157 disposed in the reservoir defined by the fifth tubular section 155.

The sensor 101 further comprises a sixth tubular section 159, one of the ends of which is bonded to the chip 102, in this embodiment by an epoxy resin, so as to overlie the second port 113 of the separation channel 109 and define a reservoir, and a sixth electrode element 161 disposed in the reservoir defined by the sixth tubular section 159.

The sensor 101 further comprises a seventh tubular section 163, one of the ends of which is bonded to the chip 102, in this embodiment by an epoxy resin, so as to overlie the port 115 of the spur channel 114 and define a reservoir, and a seventh electrode element 165 disposed in the reservoir defined by the seventh tubular section 163.

FIG. 18 illustrates a measurement system incorporating the above-described potentiometric sensor 101.

The measurement system comprises a data acquisition unit 167 for logging the electromotive force developed across the ion-selective electrode and the reference electrode of the sensor 101. In this embodiment the data acquisition unit 167 comprises a PICO-LOG™ data acquisition system connected to the ion-selective electrode and the reference electrode through a buffer amplifier for converting the high impedance voltage to a low impedance voltage.

The measurement system further comprises a d.c. high voltage supply 169 connected to the third to seventh conductive elements 149, 153, 157, 161, 165 for selectively applying a d.c. high voltage between respective ones thereof.

Operation of the measurement system is as follows. In a first step, a volume of buffer solution, typically about 1 ml, is introduced into the reservoirs defined by the third, fourth, fifth, sixth and seventh tubular sections 147, 151, 155, 159, 163 and a vacuum is applied, typically using a vacuum pump, to the sixth tubular section 159 such as to fill each of the first, second and third channels 103, 109, 114 which together typically have a volume of about 1 μl. In a second step, the third tubular section 155 is emptied of the buffer solution. In a third step, a metered volume of a sample solution, typically about 1 ml in volume, is introduced into the third tubular section 155. In a fourth step, a first voltage regime is applied to the third, fifth, sixth and seventh conductive elements 149, 157, 161, 165 such as to bring a plug of the sample solution by electrokinetic injection to the intersection of the first and second channels 103, 109. In this first voltage regime the voltages at the third, fifth, sixth and seventh conductive elements 149, 157, 161, 165 are 0.5 kV, 2 kV, −2 kV and 0 V respectively. In a fifth step, a second voltage regime is applied to the third, fifth, sixth and seventh conductive elements 149, 157, 161, 165 such as to cause analyte ions in the plug of the sample solution to migrate along the separation channel 103 in a direction towards the seventh electrode element 165. In this second voltage regime the voltages at the third, fifth, sixth and seventh conductive elements 149, 157, 161, 165 are 3 kV, 1 kV, 1 kV and 0 V respectively. As the analyte ions of the sample solution pass the junction region 125 of the first chamber 116 of the ion-selective electrode, the electromotive force generated across the ion-selective electrode and the reference electrode is logged by the data acquisition unit 167, which data can be used to provide an on-line measurement of the activity of the analyte ions. This measurement cycle can be repeated after flushing the chip 102 with buffer solution.

FIG. 19 illustrates the chip layout of a chip 102 of a potentiometric sensor 101 in accordance with a sixth embodiment of the present invention. This chip 102 is substantially identical to that of the above-described fifth embodiment, and thus in order to avoid unnecessary duplication of description only the differences will be described in detail, with like parts being designated by like reference signs. This chip 102 differs from that of the fifth-described embodiment in that the separation channel 103 is of linear section and in not including a spur channel 114. In this embodiment the junction region 135 of the second chamber 127 of the reference electrode is directly in fluid communication with the separation channel 103 at a location adjacent, but upstream of, the junction region 125 of the first chamber 116 of the ion-selective electrode with reference to the direction of migration of the analyte ions. In a particularly preferred embodiment the junction region 125 of the first chamber 116 of the ion-selective electrode and the junction region 135 of the second chamber 127 of the reference electrode are disposed at the same distance along the separation channel 103.

Finally, it will be understood that the present invention has been described in its preferred embodiments and can be modified in many different ways within the scope of the invention as defined by the appended claims. For example, the above-described embodiments could be further integrated, particularly to include deposited thin film electrodes and to incorporate the liquid-handling components. This further integration would provide for hand-held analyzers, which would find particular application as clinical tools.

1. A microfabricated potentiometric sensor, comprising:
a substrate chip;
a flow channel defined by the substrate chip through which analyte ions of a sample solution are in use driven;
at least one ion-selective electrode comprising a chamber defined by the substrate chip and including a port in communication with the flow channel, an ion-selective membrane disposed in the chamber, and a conductive element configured such as in use to be in electrical connection with the ion-selective membrane;
a reference electrode configured such as in use to be in electrical connection with the flow channel;
whereby, on driving analyte ions of a sample solution through the flow channel, an electromotive force is developed between the at least one ion-selective electrode and the reference electrode which is representative of the activity of the analyte ions.

2. A potentiometric sensor according to claim 1, wherein the chamber is filled completely by the ion-selective membrane.

3. A potentiometric sensor according to claim 1, wherein the chamber is filled partially by the ion-selective membrane.

4. A potentiometric sensor according to any of claims 1 to 3, wherein the chamber comprises a first region, and at least one second, junction region of smaller dimension than the first region in communication with the flow channel.

5. A potentiometric sensor according to claim 4, wherein the chamber comprises a plurality of junction regions, each being in communication with respective ones of spaced locations in the flow channel.

6. A potentiometric sensor according to claim 5, wherein the junction regions are in communication with locations spaced along the length of the flow channel.

7. A potentiometric sensor according to any of claims 1 to 6, wherein the at least one ion-selective electrode further comprises a reference solution, with the conductive element being disposed in the reference solution such as to be in electrical connection with the ion-selective membrane through the reference solution.

8. A potentiometric sensor according to any of claims 1 to 7, comprising a plurality of ion-selective electrodes, with the ports of the chambers of the ion-selective electrodes being in communication with respective ones of spaced locations in the flow channel.

9. A potentiometric sensor according to claim 8, wherein the ports of the chambers of the ion-selective electrodes are in communication with locations spaced along the length of the flow channel.

10. A potentiometric sensor according to any of claims 1 to 9, wherein the reference electrode comprises a further chamber defined by the substrate chip and including a port in communication with the flow channel, a conductive material disposed in the further chamber, and a further conductive element configured such as in use to be in electrical connection with the conductive material.

11. A potentiometric sensor according to claim 10, wherein the further chamber is filled completely by the conductive material.

12. A potentiometric sensor according to claim 10, wherein the chamber is filled partially by the conductive material.

13. A potentiometric sensor according to any of claims 10 to 12, wherein the further chamber comprises a first region, and at least one second, junction region of smaller dimension than the first region in communication with the flow channel.

14. A potentiometric sensor according to any of claims 10 to 13, wherein the reference electrode further comprises a further reference solution, with the further conductive element being disposed in the further reference solution such as to be in electrical connection with the conductive material through the further reference solution.

15. A potentiometric sensor according to any of claims 1 to 14, wherein the flow channel includes inlet and outlet ports through which a liquid flow of the sample solution is in use driven.

16. A potentiometric sensor according to any of claims 1 to 14, configured such that the analyte ions are electrically driven through the flow channel.

17. A potentiometric sensor according to claim 16, wherein the flow channel includes an inlet port through which a volume of a sample solution is in use introduced thereinto, and further comprising first and second conductive elements disposed such as to generate a potential gradient along the flow channel when a d.c. high voltage is applied thereacross.

18. A measurement system for measuring the activity of analyte ions in a sample solution incorporating the potentiometric sensor according to any of claims 1 to 17.

19. A method of measuring the activity of analyte ions in a sample solution, comprising the steps of:
providing a potentiometric sensor comprising a substrate chip defining a flow channel, at least one ion-selective electrode in communication with the flow channel, and a reference electrode in communication with the flow channel;
driving analyte ions of a sample solution through the flow channel; and
measuring the electromotive force developed between the at least one ion-selective electrode and the reference electrode so as to determine the activity of the analyte ions.

20. A method of measuring the activity of analyte ions in a sample solution according to claim 19, wherein the sample solution is fed as a liquid flow through the flow channel.

21. A method of measuring the activity of analyte ions in a sample solution according to claim 20, wherein the sample solution is fed through the flow channel at a flow rate of from 1 pl/s to 1 ml/s.

22. A method of measuring the activity of analyte ions in a sample solution according to claim 19, where the analyte ions are electrically driven along the flow channel.

23. A method of measuring the activity of analyte ions in a sample solution according to claim 22, wherein a volume of a sample solution is introduced into the flow channel prior to applying the driving voltage.
